(19) United States
(12) Patent Application Publication
(10) Pub. No.: US 2021/0165337 A1
(43) Pub. Date: Jun. 3, 2021

(54) IMAGE FORMING APPARATUS AND IMAGE FORMING METHOD

(71) Applicant: CANON KABUSHIKI KAISHA, Tokyo (JP)

(72) Inventors: Michiyo Sekiya, Shizuoka (JP); Kazunori Noguchi, Shizuoka (JP); Daisuke Yoshiba, Shizuoka (JP)

(21) Appl. No.: 17/103,712

(22) Filed: Nov. 24, 2020

(30) Foreign Application Priority Data
Nov. 29, 2019 (JP) 2019-217513

(51) Int. Cl. G03G 9/087; G03G 9/097; C08G 64/06; G03G 15/00

(52) U.S. Cl. CPC G03G 9/08757; G03G 15/75; C08G 64/06; G03G 9/09733

(57) ABSTRACT

An image forming apparatus in which no image smearing occurs even under high-temperature and high-humidity conditions while durability and low-temperature fixability are maintained. The image forming apparatus comprises: an electrophotographic photosensitive member comprising a support and a photosensitive layer formed on the support; an image forming unit configured to form an electrostatic image on the electrophotographic photosensitive member; a developing unit comprising a toner and configured to supply the toner to the electrostatic image formed on the electrophotographic photosensitive member for forming a toner image; and a transferring unit configured to transfer the toner image from the electrophotographic photosensitive member, wherein a surface layer of the electrophotographic photosensitive member is a surface layer comprises a binder resin (A), the toner is a toner including toner particles each containing a binder resin (B) and a wax, and the binder resin (A) has a specific structure I.

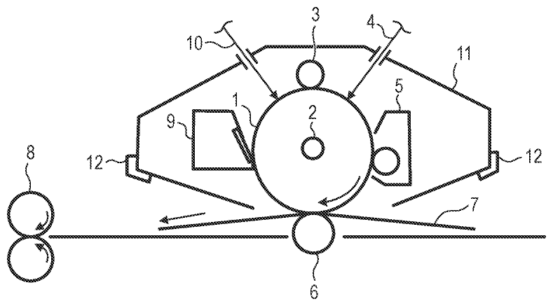

### BACKGROUND OF THE INVENTION

### Field of the Invention

The present disclosure relates to an image forming apparatus including an electrophotographic photosensitive member and a toner, and an image forming method.

### Description of the Related Art

In recent years, a wide variety of investigations have been made on an image forming apparatus including an electrophotographic photosensitive member and a toner for improving its image quality and durability. Further, an investigation on a reduction in fixation temperature has also been made for achieving energy savings in image formation. To achieve satisfactory fixation at low temperature, a reduction in melting point of the toner has been required, and at the same time, the improvement of offset resistance exhibited by a wax has also been required.

In Japanese Patent No. 6,250,637, to provide a toner excellent in balance between heat-resistant storage stability and low-temperature fixability, and excellent in hot offset resistance, there is a description of a toner containing a specific monoester compound.

In Japanese Patent Application Laid-Open No. 2015-175877, to improve durability and oil crack resistance, there is a description of an electrophotographic photosensitive member including a surface layer containing silica particles and a specific polycarbonate resin.

An investigation by the inventors has found that an image forming apparatus using the toner described in Japanese Patent No. 6,250,637 and the electrophotographic photosensitive member described in Japanese Patent Application Laid-Open No. 2015-175877 involves a disadvantage in that the quality of an image formed under high-temperature and high-humidity conditions is not necessarily sufficient, and image smearing occurs.

### SUMMARY OF THE INVENTION

Therefore, an aspect of the present disclosure is to provide an image forming apparatus and an image forming method in each of which no image smearing occurs even under high-temperature and high-humidity conditions while the durability of an electrophotographic photosensitive member and the low-temperature fixability of a toner are maintained.

The above-mentioned aspect is achieved by the present disclosure described below. That is, according to one embodiment of the present disclosure, there is provided an image forming apparatus comprising: an electrophotographic photosensitive member comprising a support and a photosensitive layer formed on the support; an image forming unit configured to form an electrostatic image on the electrophotographic photosensitive member; a developing unit comprising a toner and configured to supply the toner to the electrostatic image formed on the electrophotographic photosensitive member for forming a toner image; and a transferring unit configured to transfer the toner image from the electrophotographic photosensitive member, wherein a surface layer of the electrophotographic photosensitive member comprises a binder resin (A), and the toner comprises toner particles each containing a binder resin (B) and a wax, and wherein the binder resin (A) has a structure I represented by the general formula (1) and a structure II represented by the general formula (2), and wherein the wax comprises a monoester compound represented by the following general formula (3):

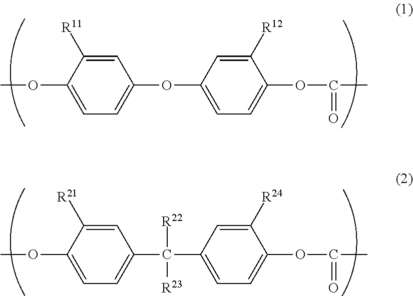

in the general formulae (1) and (2), R¹¹ and R¹², and R²¹ and R²⁴ each independently represent a hydrogen atom or a methyl group, and R²² and R²³ each independently represent a hydrogen atom, a methyl group, an ethyl group, or a phenyl group, or may form a cycloalkylidene group including a carbon atom to which R²² and R²³ are bonded;

R³¹—COO—R³² (3)

wherein, in the general formula (3), R³¹ and R³² each independently represent an alkyl group having 10 to 30 carbon atoms.

Further features of the present disclosure will become apparent from the following description of exemplary embodiments with reference to the attached drawing.

### BRIEF DESCRIPTION OF THE DRAWINGS

FIGURE is an illustration of an example of the schematic configuration of an image forming apparatus and an image forming method according to one embodiment of the present disclosure.

### DESCRIPTION OF THE EMBODIMENTS

Now, the present disclosure is described in detail by way of exemplary embodiments.

In an image forming apparatus in which the electrophotographic photosensitive member described in Japanese Patent Application Laid-Open No. 2015-175877, which comprises a binder resin, and a related-art toner are combined for improving durability, no image smearing has occurred under high-temperature and high-humidity conditions. However, the combination of the electrophotographic photosensitive member described in Japanese Patent Application Laid-Open No. 2015-175877 and the toner described in Japanese Patent No. 6,250,637, which comprises a monoester wax intended for an improvement in low-temperature fixability, has caused image smearing under high-temperature and high-humidity conditions. A reason for the foregoing is assumed to be as described below.

In the image forming apparatus in which the electrophotographic photosensitive member described in Japanese Patent Application Laid-Open No. 2015-175877, which comprises the binder resin, and the related-art toner are combined, the electrophotographic photosensitive member is more hardly shaved as the durability of the electrophotographic photosensitive member is improved. Accordingly, a charging product accumulates on the surface of the photosensitive member, and hence its amount increases. However, the charging product is scraped from the surface of the electrophotographic photosensitive member because of the presence of a rubbing effect by the toner at the time of development, and hence no image smearing has occurred. Meanwhile, the toner described in Japanese Patent No. 6,250,637, which comprises the monoester wax intended for an improvement in fixability, has such a characteristic that the monoester wax is liable to exude to the surface of a toner particle under high-temperature and high-humidity conditions. Accordingly, the rubbing of the surface of the electrophotographic photosensitive member by the toner hardly occurs. In addition, when a force occurs between the photosensitive member and a developing roller, the exudation of the monoester wax from the toner particle is liable to occur. The inventors have conceived that the monoester wax adheres to the surface of the developing roller or the electrophotographic photosensitive member owing to those factors, and hence the scraping of the charging product from the surface of the electrophotographic photosensitive member that has heretofore been expressed becomes insufficient.

The inventors have made various investigations on measures, each of which can maintain the effect by which the charging product is scraped from the surface of the electrophotographic photosensitive member while achieving both of the durability of the electrophotographic photosensitive member and the fixability of the toner, based on the above-mentioned assumption, and as a result, have reached the configuration of the present disclosure.

The surface layer of the electrophotographic photosensitive member of the present disclosure comprises a binder resin (A). In addition, the toner comprises toner particles each comprising a binder resin (B) and a wax.

The binder resin (A) has a structure I represented by the general formula (1) and a structure II represented by the general formula (2).

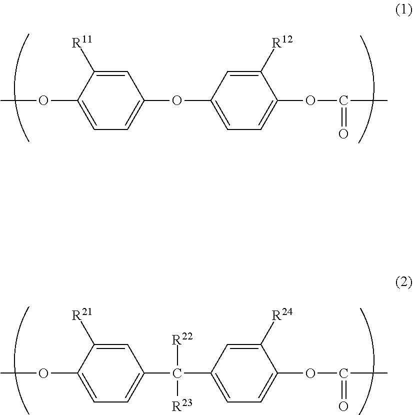

In the general formula (1) and the general formula (2), R¹¹ and R¹², and R²¹ and R²⁴ each independently represent a hydrogen atom or a methyl group, and R²² and R²³ each independently represent a hydrogen atom, a methyl group, an ethyl group, or a phenyl group, or may form a cycloalkylidene group including a carbon atom to which R²² and R²³ are bonded. Examples of the cycloalkylidene group include a cyclopropylidene group, a cyclobutylidene group, a cyclopentylidene group, a cyclohexylidene group, a cycloheptylidene group, and a cyclooctylidene group.

The structure I represented by the general formula (1) can impart elasticity to the surface layer of the electrophotographic photosensitive member. Therefore, a stress applied between the surface layer of the electrophotographic photosensitive member comprising the binder resin (A) having the structure I represented by the general formula (1) and a developing roller can be alleviated, and hence the exudation of the wax from the toner particles can be suppressed. Although a molar ratio between the structure I represented by the general formula (1) and the structure II represented by the general formula (2) may be appropriately selected, the molar ratio (the structure I:the structure II) is preferably from 25:75 to 70:30, more preferably from 25:75 to 50:50 in order that a suppressing effect on the exudation of the wax and an improving effect on the durability of the electrophotographic photosensitive member may be more synergistically exhibited.

Meanwhile, the wax comprises a monoester compound represented by the following general formula (3).

R³¹—COO—R³² (3)

In the general formula (3), R³¹ and R³² each independently represent an alkyl group having 10 to 30 carbon atoms, and may be identical to or different from each other.

The use of the monoester compound represented by the general formula (3) facilitates the control of the state of presence of the wax in each of the toner particles. In addition, the monoester compound represented by the general formula (3) is preferred because the compound has moderate compatibility with the binder resin (B) used in each of the toner particles, and hence easily achieves both of low-temperature fixability and the storage stability of the toner.

In addition, the inventors have found that there is a relationship between the ratio of the structure represented by the formula (1) in the binder resin (A) and the ratio of the amount of the wax to the binder resin (B) in each of the toner particles. That is, a ratio between the molar ratio I of the structure I represented by the general formula (1) to the binder resin (A) and the molar ratio II of the monoester compound represented by the formula (3) to the binder resin (B) of the toner (the molar ratio I:the molar ratio II) is preferably from 3:1 to 1:1. When the ratio falls within the range, both of the suppressing effect on the exudation of the wax from the toner particles and the effect by which a charging product is scraped from the surface of the electrophotographic photosensitive member are achieved.

When the respective configurations synergistically affect each other via the foregoing mechanism, the effect of the present disclosure can be achieved.

[Toner]

The toner to be used in the present disclosure is further described below.

The toner to be used in an image forming apparatus according to the present disclosure is characterized in that: the toner comprises the toner particles; the toner particles each comprise the binder resin (B) and the wax; and the wax comprises the monoester compound represented by the formula (3).

The binder resin (B) is not particularly limited, and a known resin for a toner may be used. Specific examples thereof comprise a vinyl-based resin, a styrene-based resin, a styrene-based copolymer resin, a polyester resin, a polyol resin, a polyvinyl chloride resin, a phenol resin, a natural-modified phenol resin, a natural resin-modified maleic acid resin, an acrylic resin, a methacrylic resin, polyvinyl acetate, a silicone resin, a polyurethane resin, a polyamide resin, a furan resin, an epoxy resin, a xylene resin, polyvinyl butyral, a terpene resin, a coumarone-indene resin, and a petroleum-based resin. Of those, for example, a styrene-based copolymer resin, a polyester resin, or a hybrid resin obtained by mixing or partially reacting a polyester resin and a vinyl-based resin is preferably used as the resin.

Of those, the vinyl-based resin is preferably used from the viewpoint of compatibility with the monoester wax, and the styrene-based copolymer resin is more preferred.

In addition, a method of producing the toner of the present disclosure is not particularly limited as long as the monoester compound represented by the general formula (3) is used as its wax. The toner may be produced by a pulverization method, or may be produced by a method comprising producing the toner particles in an aqueous medium, such as a dispersion polymerization method, an association aggregation method, a dissolution suspension method, a suspension polymerization method, or an emulsion aggregation method.

However, the method comprising producing the toner particles in the aqueous medium is preferred from the viewpoint of controlling the state of presence of the monoester compound represented by the general formula (3), and the toner is particularly preferably produced by the suspension polymerization method from the viewpoint of controlling the shapes of the toner particles.

The suspension polymerization method is described below.

The suspension polymerization method is a method comprising: uniformly dissolving or dispersing a polymerizable monomer and a colorant (and, as required, a polymerization initiator, a crosslinking agent, a charge control agent, or any other additive) to provide a polymerizable monomer composition; and then dispersing the polymerizable monomer composition in a continuous phase (e.g., an aqueous phase) comprising a dispersant with an appropriate stirrer, and at the same time, performing a polymerization reaction to provide a toner having a desired particle diameter. An improvement in image quality can be expected from toner particles obtained by the suspension polymerization method because the shapes of the respective toner particles are substantially uniformized to spherical shapes, and hence the charge quantity distribution thereof becomes relatively uniform.

Examples of the polymerizable monomer for forming the polymerizable monomer composition in the production of the toner particles by the suspension polymerization method comprise the following monomers.

As a main component of the polymerizable monomer, a monovinyl monomer is preferably used. Examples of the monovinyl monomer include: styrene; styrene derivatives, such as vinyltoluene and α-methylstyrene; acrylic acid and methacrylic acid; acrylic acid esters, such as methyl acrylate, ethyl acrylate, propyl acrylate, butyl acrylate, 2-ethylhexyl acrylate, and dimethylaminoethyl acrylate; methacrylic acid esters, such as methyl methacrylate, ethyl methacrylate, propyl methacrylate, butyl methacrylate, 2-ethylhexyl methacrylate, and dimethylaminoethyl methacrylate; nitrile compounds, such as acrylonitrile and methacrylonitrile; amide compounds, such as acrylamide and methacrylamide; and olefins, such as ethylene, propylene, and butylene. Those monovinyl monomers may be used alone or in combination thereof. Of those, styrene, a styrene derivative, and an acrylic acid ester or a methacrylic acid ester is suitably used as the monovinyl monomer.

Examples of the polymerization initiator to be used in the production of toner particles through polymerization include: persulfates, such as potassium persulfate and ammonium persulfate; azo compounds, such as 4,4′-azobis(4-cyanovaleric acid), 2,2′-azobis(2-methyl-N-(2-hydroxyethyl)propionamide), 2,2′-azobis(2-amidinopropane) dihydrochloride, 2,2′-azobis(2,4-dimethylvaleronitrile), and 2,2′-azobisisobutyronitrile; and organic peroxides, such as di-t-butyl peroxide, benzoyl peroxide, t-butyl peroxy-2-ethyl hexanoate, t-butyl peroxydiethyl acetate, t-hexyl peroxy-2-ethyl butanoate, diisopropyl peroxydicarbonate, di-t-butyl peroxyisophthalate, and t-butyl peroxyisobutyrate. Those polymerization initiators may be used alone or in combination thereof. Of those, an organic peroxide is preferably used because the peroxide can reduce the amount of the remaining polymerizable monomer, and is excellent in printing durability.

Of the organic peroxides, a peroxyester is preferred because the peroxyester has satisfactory initiator efficiency and can reduce the amount of the remaining polymerizable monomer, and a nonaromatic peroxyester, that is, a peroxyester free of any aromatic ring is more preferred.

The polymerization initiator may be added after the dispersion of the polymerizable monomer composition in the aqueous medium and before liquid droplet formation as described in the foregoing, or may be added to the polymerizable monomer composition before the dispersion in the aqueous medium.

The addition amount of the polymerization initiator to be used in the polymerization of the polymerizable monomer composition is preferably 0.1 to 20 parts by mass, more preferably 0.3 to 15 parts by mass, particularly preferably 1 to 10 parts by mass with respect to 100 parts by mass of the monovinyl monomer.

When the toner particles are produced through polymerization, the crosslinking agent may be added. A preferred addition amount of the crosslinking agent is 0.001 to 15 parts by mass with respect to 100 parts by mass of the polymerizable monomer.

Herein, as the cross-linking agent, a compound having 2 or more polymerizable double bonds is mainly used. Examples thereof may include: aromatic divinyl compounds, such as divinylbenzene, divinylnaphthalene, and derivatives thereof; ester compounds in each of which 2 or more carboxylic acids each having a carbon-carbon double bond are bonded to an alcohol having 2 or more hydroxy groups through an ester bond, such as ethylene glycol dimethacrylate and diethylene glycol dimethacrylate; other divinyl compounds, such as N,N-divinylaniline and divinyl ether; and compounds each having 3 or more vinyl groups. Those cross-linking agents may be used alone or in combination thereof.

In the present disclosure, the monoester compound represented by the general formula (3) is used as the wax.

A preferred monoester compound is described below.

The monoester compound of the present disclosure is such that the number of carbon atoms of the alkyl group represented by each of R³¹ and R³² in the monoester compound represented by the general formula (3) is preferably from 10 to 30, more preferably from 15 to 25, still more preferably from 18 to 22. In addition, R³¹ and R³² may be identical to or different from each other.

In addition, the number of carbon atoms that one molecule of the monoester compound comprises is preferably 36 to 44.

The alcohol for forming the monoester compound is preferably an aliphatic alcohol. Specific examples thereof include 1-hexanol, 1-heptanol, 1-octanol, 1-nonanol, 1-decanol, undecyl alcohol, lauryl alcohol, myristyl alcohol, 1-hexadecanol, stearyl alcohol, arachidyl alcohol, behenyl alcohol, and lignoceryl alcohol. In addition, the carboxylic acid for forming the monoester compound is preferably an aliphatic carboxylic acid. Specific examples thereof include pentanoic acid, hexanoic acid, heptanoic acid, octanoic acid, nonanoic acid, decanoic acid, lauric acid, myristic acid, palmitic acid, stearic acid, arachidic acid, behenic acid, and lignoceric acid.

Specific examples of the monoester compound represented by the general formula (3) include behenyl stearate (C₁₇H₃₅—COO—C₂₂H₄₅), eicosyl eicosanoate (C₁₉H₃₉—COO—C₂₀H₄₁), stearyl behenate (C₂₁H₄₃—COO—C₁₈H₃₇), and hexadecyl lignocerate (C₂₃H₄₇—COO—C₁₆H₃₃). Of those monoester compounds, behenyl stearate and stearyl behenate are each more preferred as the monoester compound.

Although the effect of the present disclosure can be obtained as long as the component represented by the general formula (3) is used as a main component of the monoester compound, the content of the monoester compound represented by the general formula (3) in the monoester compound is preferably 95 mass % or more.

Further, the acid value of the monoester compound represented by the general formula (3) is preferably 1.0 mgKOH/g or less, more preferably 0.6 mgKOH/g or less, still more preferably 0.3 mgKOH/g or less. When the acid value is more than 1.0 mgKOH/g, the storage stability of the toner may deteriorate.

In addition, the content of the monoester compound represented by the formula (3) that the toner particles comprise is preferably 10 to 30 parts by mass with respect to 100 parts by mass of the binder resin (B). When the particles comprise 10 parts by mass or more of the resin, the effect of the present disclosure is stably obtained. In addition, the storage stability of the toner is improved by setting the content to 30 parts by mass or less.

In addition, in the present disclosure, the toner particles may each use any other wax in addition to the monoester compound represented by the general formula (3).

Specific examples of the other wax include: aliphatic hydrocarbons, such as low-molecular-weight polyethylene, low-molecular-weight polypropylene, a microcrystalline wax, a paraffin wax, and a Fischer-Tropsch wax; and polyfunctional ester waxes, for example: pentaerythritol ester compounds, such as pentaerythritol tetrapalminate, pentaerythritol tetrabehenate, and pentaerythritol tetrastearate; glycerin ester compounds, such as hexaglycerin tetrabehenate tetrapalminate, hexaglycerin octabehenate, pentaglycerin heptabehenate, tetraglycerin hexabehenate, triglycerin pentabehenate, diglycerin tetrabehenate, and glycerin tribehenate; and dipentaerythritol ester compounds, such as dipentaerythritol hexamyristate and dipentaerythritol hexapalminate.

In addition, the melting point of each of the monoester compound represented by the general formula (3) and the other wax is preferably 60 to 75° C., more preferably 65 to 75° C.

The melting point is preferably set within the above-mentioned ranges because both of the storage stability and low-temperature fixability of the toner are easily achieved.

In addition, the content of the monoester wax is preferably 95 mass % or more with respect to the wax in the toner.

Although a method of producing the wax comprising the monoester compound represented by the general formula (3) is not particularly limited, examples thereof comprise: a synthesis method based on an oxidation reaction; synthesis from a carboxylic acid and a derivative thereof; an ester group-introducing reaction typified by the Michael addition reaction; a method comprising utilizing a dehydration condensation reaction between a carboxylic acid compound and an alcohol compound; a reaction between an acid halide and an alcohol compound; and an ester exchange reaction. A catalyst may be appropriately used in any such production method for the monoester compound. The catalyst is preferably a general acidic or alkaline catalyst to be used in an esterification reaction, such as zinc acetate or a titanium compound. After the esterification reaction, a target product may be purified through, for example, recrystallization or distillation.

Specific production examples of the monoester compound represented by the general formula (3) are described below.

First, the alcohol and the carboxylic acid serving as raw materials are loaded into a reaction vessel. A molar ratio between the alcohol and the carboxylic acid is appropriately adjusted in accordance with the chemical structure of the target monoester compound. That is, in the case of the monoester compound, the alcohol and the carboxylic acid are mixed so that the molar ratio between the alcohol and the carboxylic acid may be 1:1. One of the alcohol and the carboxylic acid may be added in a slightly excess amount with respect to the ratio in consideration of, for example, reactivity in a dehydration condensation reaction between the raw materials.

Next, the mixture is appropriately heated to perform the dehydration condensation reaction. A basic aqueous solution and, as appropriate, an organic solvent are added to an esterified crude product obtained by the dehydration condensation reaction to deprotonate the alcohol and the carboxylic acid that are unreacted, followed by the separation of the deprotonated products into an aqueous phase. After that, water washing, solvent evaporation, and filtration are appropriately performed. Thus, the monoester compound can be obtained.

In addition, when a color toner is produced, a black, cyan, yellow, or magenta colorant may be used.

Examples of the black colorant include carbon black, titanium black, and magnetic powders, such as zinc iron oxide and nickel iron oxide.

As the cyan colorant, for example, a copper phthalocyanine compound or a derivative thereof, and an anthraquinone compound may be used. Specific examples thereof include C.I. Pigment Blue 2, 3, 6, 15, 15:1, 15:2, 15:3, 15:4, 16, 17:1, and 60.

As the yellow colorant, a compound, for example, an azo-based pigment, such as a monoazo pigment or a disazo pigment, or a fused polycyclic pigment may be used. Examples thereof include C.I. Pigment Yellow 3, 12, 13, 14, 15, 17, 62, 65, 73, 74, 83, 93, 97, 120, 138, 155, 180, 181, 185, 186, and 213.

As the magenta colorant, a compound, for example, an azo-based pigment, such as a monoazo pigment or a disazo pigment, or a fused polycyclic pigment may be used. Examples thereof include C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255, and 269, and C.I. Pigment Violet 19.

The respective colorants may be used alone or in combination thereof. The amount of the colorant is preferably 1 to 10 parts by mass with respect to 100 parts by mass of the monovinyl monomer.

A positively chargeable or negatively chargeable charge control agent may be used as the other additive for improving the chargeability of the toner. The charge control agent is not particularly limited as long as the agent is generally used as a charge control agent for a toner. Of the charge control agents, however, a positively chargeable or negatively chargeable charge control resin is preferred because the resin has high compatibility with the polymerizable monomer, and can impart stable chargeability (charging stability) to each of the toner particles. Further, the positively chargeable charge control resin is more preferably used from the viewpoint of obtaining a positively chargeable toner.

Examples of the positively chargeable charge control agent include: a nigrosine dye, a quaternary ammonium salt, a triaminotriphenylmethane compound, and an imidazole compound; and a polyamine resin, a quaternary ammonium group-comprising copolymer, and a quaternary ammonium salt group-comprising copolymer each serving as a charge control resin to be preferably used.

Examples of the negatively chargeable charge control agent include: an azo dye, a salicylic acid metal compound, and an alkylsalicylic acid metal compound comprising metals such as Cr, Co, Al, and Fe; and a sulfonic acid group-comprising copolymer, a sulfonic acid salt group-comprising copolymer, a carboxylic acid group-comprising copolymer, and a carboxylic acid salt group-comprising copolymer each serving as a charge control resin to be preferably used.

In the present disclosure, it is desired that the charge control agent be used at a ratio of typically 0.01 to 10 parts by mass, preferably 0.03 to 8 parts by mass with respect to 100 parts by mass of the monovinyl monomer. When the addition amount of the charge control agent is less than 0.01 part by mass, fogging may occur. Meanwhile, when the addition amount of the charge control agent is more than 10 parts by mass, printing contamination may occur.

In addition, a molecular weight modifier is preferably used as the other additive at the time of the polymerization of a polymerizable monomer that is polymerized to provide the binder resin (B).

The molecular weight modifier is not particularly limited as long as the molecular weight modifier is used as a general molecular weight modifier for a toner. Examples thereof include: mercaptans, such as t-dodecylmercaptan, n-dodecylmercaptan, n-octylmercaptan, and 2,2,4,6,6-pentamethylheptane-4-thiol; and thiuram disulfides, such as tetramethylthiuram disulfide, tetraethylthiuram disulfide, tetrabutylthiuram disulfide, N,N′-dimethyl-N,N′-diphenylthiuram disulfide, and N,N′-dioctadecyl-N,N′-diisopropylthiuram disulfide. Those molecular weight modifiers may be used alone or in combination thereof.

In the present disclosure, it is desired that the molecular weight modifier be used at a ratio of typically 0.01 to 10 parts by mass, preferably 0.1 to 5 parts by mass with respect to 100 parts by mass of the monovinyl monomer.

In a method of producing the toner particles through polymerization, the toner particles may be generally produced by: appropriately adding the above-mentioned materials and the like; uniformly dissolving or dispersing the materials with a dispersing machine, such as a homogenizer, a ball mill, or an ultrasonic dispersing machine, to provide a polymerizable monomer composition; and suspending the polymerizable monomer composition in an aqueous medium comprising a dispersant, followed by its polymerization. At this time, when the composition is granulated into desired toner particle sizes with a high-speed dispersing machine, such as a high-speed stirring machine or an ultrasonic dispersing machine, in one stroke, the particle diameters of the toner particles to be obtained become sharper. With regard to the time point at which the polymerization initiator is added, the initiator may be added simultaneously with the addition of the other additive to the polymerizable monomer, or may be mixed into the aqueous medium immediately before the composition is suspended thereinto. In addition, the polymerizable monomer or the polymerization initiator dissolved in a solvent may be added immediately after the granulation and before the initiation of the polymerization reaction.

After the granulation, stirring only needs to be performed with a typical stirring machine to such an extent that the states of the particles are maintained, and the floating and sedimentation of the particles are prevented.

When the toner particles of the present disclosure are produced, a known surfactant, or a known organic dispersant or inorganic dispersant may be used as the dispersant. Of those, the inorganic dispersant may be preferably used because of the following reasons: the dispersant obtains dispersion stability by virtue of its steric hindrance, and hence the stability hardly collapses even when a reaction temperature is changed; and the dispersant is easily washed off, and hence hardly has an adverse effect on the toner. Examples of such inorganic dispersant include: sulfates, such as barium sulfate and calcium sulfate; carbonates, such as barium carbonate, calcium carbonate, and magnesium carbonate; phosphates, such as calcium phosphate; metal oxides, such as aluminum oxide and titanium oxide; and metal hydroxides, such as aluminum hydroxide, magnesium hydroxide, and ferric hydroxide.

Any such inorganic dispersant is desirably used in an amount of 0.2 to 20 parts by mass with respect to 100 parts by mass of the polymerizable monomer. The dispersants may be used alone or in combination thereof. Further, the surfactant may be used in an amount of 0.001 to 0.1 part by mass in combination with the dispersant.

In the step of polymerizing the polymerizable monomer, a polymerization temperature is preferably 50° C. or more, more preferably 60 to 95° C. In addition, the reaction time of the polymerization is preferably 1 to 20 hours, more preferably 2 to 15 hours.

So-called core-shell type (capsule type) toner particles obtained as follows are preferably adopted: polymer particles each comprising the colorant, which are obtained through the polymerization reaction, are each used as a core layer, and a shell layer different from the core layer is formed on the outside of the core layer. The core-shell type toner particles can achieve balance between a reduction in fixation temperature and the prevention of their aggregation at the time of storage through the coating of the core layer, which is formed of a substance having a low softening point, with a substance having a softening point higher than that of the foregoing substance.

A method of producing the core-shell type toner particles through use of the above-mentioned polymer particles is not particularly limited, and the particles may be produced by a conventionally known method. An in situ polymerization method or a phase separation method is preferred in terms of production efficiency.

A method of producing the core-shell type toner particles based on the in situ polymerization method is described below.

A polymerizable monomer for forming the shell layer (polymerizable monomer for a shell) and a polymerization initiator are added to the aqueous medium having dispersed therein the polymer particles, and the polymerizable monomer is polymerized. Thus, the core-shell type toner particles can be obtained.

The same polymers as the polymerizable monomers described in the foregoing may each be used as the polymerizable monomer for a shell. Of those, monomers each providing a polymer having a glass transition temperature Tg of more than 80° C., such as styrene, acrylonitrile, and methyl methacrylate, are preferably used alone or in combination thereof.

Examples of the polymerization initiator to be used in the polymerization of the polymerizable monomer for a shell may comprise water-soluble polymerization initiators, for example: metal persulfates, such as potassium persulfate and ammonium persulfate; and azo-based initiators, such as 2,2′-azobis(2-methyl-N-(2-hydroxyethyl)propionamide), 2,2′-azobis-(2-methyl-N-(1,1-bis(hydroxymethyl)-2-hydroxyethyl)propionamide), 2,2′-azobis[N-(2-carboxyethyl)-2-methylpropionamidine], and hydrates thereof. Those polymerization initiators may be used alone or in combination thereof. The amount of the polymerization initiator is preferably 0.1 to 30 parts by mass, more preferably 1 to 20 parts by mass with respect to 100 parts by mass of the polymerizable monomer for a shell.

The polymerization temperature of the shell layer is preferably 50° C. or more, more preferably 60 to 95° C. In addition, the reaction time of the polymerization is preferably 1 to 20 hours, more preferably 2 to 15 hours.

In addition, the resultant polymer particles may be filtered out, washed, and dried by known methods to provide the toner particles. In addition, a classification step may be incorporated as required to remove coarse powder and fine powder in the toner particles.

The toner of the present disclosure can be obtained by mixing the toner particles with fine powder or the like as required to cause the powder or the like to adhere to the surfaces of the toner particles.

A stirring machine for performing the mixing treatment is not particularly limited as long as the machine is a stirring apparatus capable of causing the fine powder to adhere to the surfaces of the toner particles, and external addition treatment may be performed with any one of stirring machines capable of mixing and stirring, such as FM MIXER (product name, manufactured by Nippon Coke & Engineering Co., Ltd.), SUPER MIXER (product name, manufactured by Kawata MFG. Co., Ltd.), Q MIXER (product name, manufactured by Nippon Coke & Engineering Co., Ltd.), MECHANOFUSION SYSTEM (product name, manufactured by Hosokawa Micron Corporation), and MECHANOMILL (product name, manufactured by Okada Seiko Co., Ltd.).

Examples of the fine powder comprise: inorganic fine particles formed of silica, titanium oxide, aluminum oxide, zinc oxide, tin oxide, calcium carbonate, calcium phosphate, and/or cerium oxide; and organic fine particles formed of a polymethyl methacrylate resin, a silicone resin, and/or a melamine resin. Of those, inorganic fine particles are preferred. Of the inorganic fine particles, fine particles formed of silica and/or titanium oxide are preferred, and fine particles formed of silica are particularly suitable.

Those external additives may be used alone or in combination thereof.

In the present disclosure, it is preferred that the fine powder be used at a ratio of typically 0.05 to 6 parts by mass, preferably 0.2 to 5 parts by mass with respect to 100 parts by mass of the toner particles.

In addition, the melting temperature Tm of the toner particles of the present disclosure in a flow tester based on a ½ method is preferably 100 to 150° C., more preferably 110 to 140° C., still more preferably 120 to 130° C.

The melting temperature is preferably controlled within the above-mentioned ranges because both of the low-temperature fixability and hot offset resistance of the toner are easily achieved.

In addition, the glass transition temperature Tg of the toner particles of the present disclosure is preferably 44 to 60° C., more preferably 46 to 58° C., still more preferably 47 to 54° C.

In addition, the number-average molecular weight (Mn) of the toner particles is preferably 5,000 to 20,000, more preferably 7,000 to 15,000, still more preferably 8,000 to 10,000 in terms of polystyrene. When the number-average molecular weight of the toner particles is excessively large, the low-temperature fixability of the toner may deteriorate. In contrast, when the number-average molecular weight is excessively small, the heat-resistant storage stability thereof may deteriorate.

The weight-average molecular weight (Mw) of the toner particles is preferably 100,000 to 400,000, more preferably 200,000 to 300,000 in terms of polystyrene. When the weight-average molecular weight of the toner particles is excessively large, the low-temperature fixability of the toner may deteriorate. In contrast, when the weight-average molecular weight is excessively small, the heat-resistant storage stability thereof may deteriorate.

The molecular weight distribution (Mw/Mn) of the toner particles is preferably 10 to 40, more preferably 15 to 35. When the molecular weight distribution of the toner particles is excessively large, the low-temperature fixability and storage stability of the toner may deteriorate. In contrast, when the molecular weight distribution is excessively small, the hot offset resistance thereof may deteriorate.

Next, methods of measuring the respective physical properties related to the present disclosure are described.

<Method of measuring ½ Method Melting Temperature Tm of Toner Particles>

The melting temperature Tm of the toner particles in a flow tester based on a ½ method may be calculated from the melt viscosity thereof measured with the flow tester.

Specifically, 1.0 to 1.3 g of the toner particles were loaded into an elevated flow tester (product name: CFT-500C, manufactured by Shimadzu Corporation), and their melting temperature (Tm) based on the ½ method was measured under the following measurement conditions.

| | |
|---|---|
| Measurement start temperature: | 40° C. |
| Rate of temperature increase: | 3° C./min |
| Preheating time: | 5 minutes |
| Cylinder pressure: | 10 kgf/cm² |
| Die diameter: | 0.5 mm |
| Die length: | 1.0 mm |
| Shear stress: | 2.451 × 10⁵ Pa |

<Method of measuring Glass Transition Temperature Tg of Toner Particles>

The glass transition temperature Tg of the toner particles may be measured in conformity with, for example, ASTM D 3418-97.

Specifically, about 10 mg of the toner particles obtained through drying were precisely weighed, and the precisely weighed measurement sample was loaded into an aluminum pan, followed by the measurement of the glass transition temperature Tg of the toner particles in the measurement temperature range of from 0° C. to 150° C. under the condition of a rate of temperature increase of 10° C./min with a differential scanning calorimeter (product name: DSC6220, manufactured by SII NanoTechnology Inc.) in accordance with ASTM D 3418-97 through use of an empty aluminum pan as a reference.

<Method of measuring Molecular Weight of Toner>

The number-average molecular weight (Mn), weight-average molecular weight (Mw), and molecular weight distribution (Mw/Mn) of the toner particles may be measured in terms of polystyrene by, for example, gel permeation chromatography (GPC) comprising using tetrahydrofuran (THF).

Specifically, the measurement was performed by using the following method.

### (A) Sample Preparation

About 10 mg of the toner particles were dissolved in 5 mL of a tetrahydrofuran solvent, and the solution was left to stand at 25° C. for 16 hours. After that, the solution was passed through a membrane filter having an aperture of 0.45 μm to provide a sample.

### (B) Measurement Conditions

Temperature: 350° C., solvent: tetrahydrofuran, flow rate: 1.0 mL/min, concentration: 0.2 wt %, sample injection amount: 100 μL

### (C) Column

GPC TSKgel Multipore HXL-M (30 cm×2 columns) manufactured by Tosoh Corporation was used. The measurement was performed under the following condition: in the range of the weight-average molecular weight (Mw) in terms of polystyrene of from 1,000 or more to 300,000 or less, a first-order correlation coefficient between Log(Mw) and an elution time was 0.98 or more.

<Method of measuring Melting Point of Wax>

6 to 8 mg of a softening agent sample was weighed in a sample holder, and measurement was performed with a differential scanning thermal analyzer (product name: RDC-220, manufactured by Seiko Instruments Inc.) under such a condition that the temperature of the sample was increased from −200° C. to 1,000° C. at 100° C./min Thus, a DSC curve was obtained. The top of a peak in the DSC curve was adopted as the melting point of the sample.

<Method of measuring Acid Value of Wax>

The acid value of the wax was measured in conformity with JIS K 0070, which was a standard approach to analyzing fats and oils established by the Japanese Industrial Standards Committee (JISC).

[Electrophotographic Photosensitive Member]

The electrophotographic photosensitive member to be used in the present disclosure is further described below.

The electrophotographic photosensitive member comprises at least a support and a photosensitive layer formed on the support.

A method of producing the electrophotographic photosensitive member is, for example, a method involving: preparing coating liquids for the respective layers to be described later; applying the liquids in a desired order of the layers; and drying the liquids. In this case, examples of the method of applying the coating liquid comprise dip coating, spray coating, inkjet coating, roll coating, die coating, blade coating, curtain coating, wire bar coating, and ring coating. Of those, dip coating is preferred from the viewpoints of efficiency and productivity.

Now, the respective configurations are described.

<Support>

The support is preferably a conductive support having conductivity. In addition, examples of the shape of the support include a cylindrical shape, a belt shape, and a sheet shape. Of those, a cylindrical support is preferred. In addition, the surface of the support may be subjected to, for example, electrochemical treatment, such as anodization, blast treatment, or cutting treatment.

A metal, a resin, glass, or the like is preferred as a material for the support.

Examples of the metal include aluminum, iron, nickel, copper, gold, stainless steel, and alloys thereof. Of those, an aluminum support using aluminum is preferred.

In addition, conductivity may be imparted to the resin or the glass through treatment involving, for example, mixing or coating the resin or the glass with a conductive material.

<Undercoat Layer>

The undercoat layer may be arranged on the support. The arrangement of the undercoat layer can improve an adhesive function between layers to impart a charge injection-inhibiting function.

The undercoat layer preferably comprises a resin. In addition, the undercoat layer may be formed as a cured film by polymerizing a composition comprising a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further comprise an electron-transporting substance, a metal oxide, a metal, a conductive polymer, and the like for the purpose of improving electric characteristics. Of those, an electron-transporting substance and a metal oxide are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-comprising compound. An electron-transporting substance having a polymerizable functional group may be used as the electron-transporting substance and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further comprise an additive.

The undercoat layer has an average thickness of preferably 0.1 to 50 μm, more preferably 0.2 to 40 μm, particularly preferably 0.3 to 30 μm.

The undercoat layer may be formed by preparing a coating liquid for an undercoat layer comprising the above-mentioned materials and a solvent, forming a coat thereof, and drying and/or curing the coat. Examples of the solvent to be used for the coating liquid include an alcohol-based solvent, a ketone-based solvent, an ether-based solvent, an ester-based solvent, and an aromatic hydrocarbon-based solvent.

<Photosensitive Layer>

The photosensitive layers of electrophotographic photosensitive members are mainly classified into (1) a single-layer photosensitive layer and (2) a laminated photosensitive layer. (1) The single-layer photosensitive layer comprises a photosensitive layer comprising all of a charge-generating substance, a hole-transporting substance, and the electron-transporting substance. (2) The laminated photosensitive layer comprises a charge-generating layer comprising the charge-generating substance and a charge-transporting layer comprising the hole-transporting substance. In one embodiment of the present disclosure, the photosensitive layer is the surface layer of the electrophotographic photosensitive member.

(1) Single-Layer Photosensitive Layer

The single-layer photosensitive layer comprising the charge-generating substance, the hole-transporting substance, the electron-transporting substance, and a resin solvent.

The binder resin (A) to be used in the photosensitive layer has the structure I represented by the general formula (1) and the structure II represented by the general formula (2).

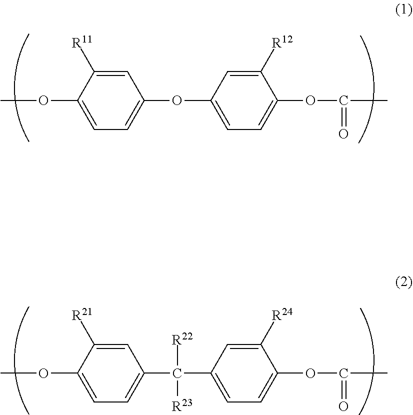

In the general formula (1) and the general formula (2), R¹¹ and R¹², and R²¹ and R²⁴ each independently represent a hydrogen atom or a methyl group, and R²² and R²³ each independently represent a hydrogen atom, a methyl group, an ethyl group, or a phenyl group, or may form a cycloalkylidene group including a carbon atom to which R²² and R²³ are bonded.

In the general formula (2), it is preferred that R²² represent a methyl group and R²³ represent an ethyl group.

With regard to the molecular weight of the binder resin (A), its weight-average molecular weight (Mw) preferably falls within the range of from 10,000 or more to 300,000.

Specific examples of the binder resin (A) are shown in Table 1. In Table 1, the column “General formula (1)” shows the structure I represented by the general formula (1), the column “General formula (2)” shows the structure II represented by the general formula (2), and the column “Molar ratio (1):(2)” shows the molar ratio between the structure I represented by the general formula (1) and the structure II represented by the general formula (2).

TABLE 1

| | General | General | | | Molar |
|---|---|---|---|---|---|
| | Formula (1) | Formula (2) | | | ratio |
| | R¹¹, R¹² | R²¹, R²⁴ | R²² | R²³ | (1):(2) |
| Resin 1 | H | H | Methyl | Ethyl | 30:70 |
| Resin 2 | H | H | Methyl | Ethyl | 25:75 |
| Resin 3 | H | H | Methyl | Ethyl | 35:65 |
| Resin 4 | H | H | Methyl | Ethyl | 40:60 |
| Resin 5 | H | H | Methyl | Ethyl | 50:50 |
| Resin 6 | H | H | Methyl | Ethyl | 20:80 |
| Resin 7 | H | H | Cyclohexylidene | | 30:70 |
| Resin 8 | H | H | Methyl | Methyl | 30:70 |
| Resin 9 | H | H | Methyl | Phenyl | 30:70 |
| Resin 10 | H | H | Hydrogen | Methyl | 30:70 |
| Resin 11 | Methyl | H | Methyl | Ethyl | 30:70 |
| Resin 12 | H | Methyl | Methyl | Methyl | 30:70 |
| Resin 13 | Methyl | Methyl | Methyl | Ethyl | 30:70 |

The photosensitive layer may comprise a resin except the binder resin (A) to the extent that the effect of the present disclosure is not impaired. Examples of the other resin include a polycarbonate resin, a styrene resin, and an acrylic resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, a metal-free phthalocyanine, an oxytitanium phthalocyanine pigment, a chlorogallium phthalocyanine pigment, and a hydroxygallium phthalocyanine pigment are preferred.

Examples of the hole-transporting substance include a polycyclic aromatic compound, a heterocyclic compound, a hydrazone compound, a styryl compound, an enamine compound, a benzidine compound, a triarylamine compound, and a resin having a group derived from each of those substances. Those hole-transporting substances may be used alone or in combination thereof. Of those, a triarylamine compound and a benzidine compound are preferred.

Examples of the electron-transporting substance include a quinone-based compound, a diimide-based compound, a hydrazone-based compound, a malononitrile-based compound, a thiopyran-based compound, a trinitrothioxanthone-based compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacridine, succinic anhydride, maleic anhydride, and dibromomaleic anhydride. Examples of the quinone-based compound include a diphenoquinone-based compound, an azoquinone-based compound, an anthraquinone-based compound, a naphthoquinone-based compound, a nitroanthraquinone-based compound, and a dinitroanthraquinone-based compound. Those electron-transporting substances may be used alone or in combination thereof.

Of those, compounds represented by the following general formula (4) to the following general formula (12) are each preferred as the electron-transporting substance. When compatibility between the binder resin (A) and electron-transporting substance of the present disclosure becomes higher to improve the uniformity of the photosensitive member, the suppressing effect on the exudation of the wax to the surface of the toner, which is the effect of the present disclosure, may be improved.

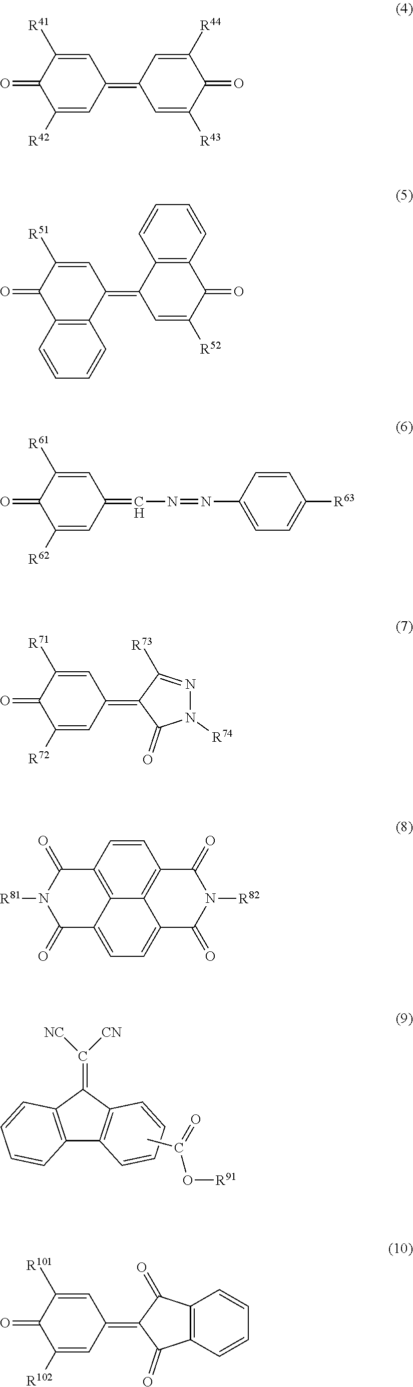

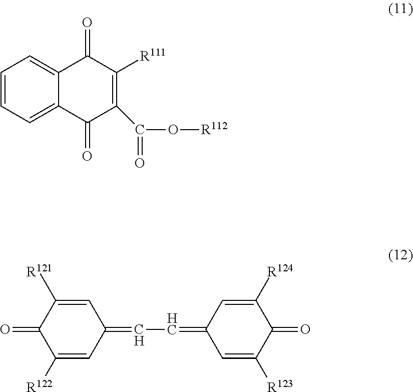

In the general formula (4) to the general formula (12), R⁴¹ to R⁴⁴, R⁵¹, R⁵², R₆₁, R₆₂, R₇₁ to R₇₃, R₁₀₁, R₁₀₂, and R₁₂₁ to R₁₂₄ each independently represent a hydrogen atom or an alkyl group having 1 to 6 carbon atoms, and R⁶³ represents a hydrogen atom, a halogen atom, or an alkyl group having 1 to 6 carbon atoms, R⁷⁴, R⁸¹, and R⁸² each independently represent an alkyl group having 1 to 6 carbon atoms, or a phenyl group that may have a halogen atom or an alkyl group having 1 to 6 carbon atoms, R⁹¹ represents a hydrogen atom or an alkyl group having 1 to 6 carbon atoms that may have a halogen atom, and R¹¹¹ and R¹¹² each independently represent an alkyl group having 1 to 6 carbon atoms that may have a halogen group, a phenyl group that may have a halogen group or an alkyl group having 1 to 6 carbon atoms, or a benzyl group that may have a halogen group or an alkyl group having 1 to 6 carbon atoms.

Specific examples of the compounds represented by the general formula (4) to the general formula (12) are shown in Table 2.

TABLE 2

| | |
|---|---|
| 4-1 | 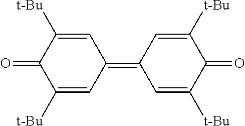 [SMILES: CC(C)(C)C1=CC(=C2C=C(C(C)(C)C)C(=O)C(C(C)(C)C)=C2)C=C(C(C)(C)C)C1=O] |
| 4-2 | 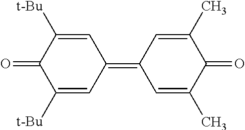 [SMILES: CC1=CC(=C2C=C(C(C)(C)C)C(=O)C(C(C)(C)C)=C2)C=C(C)C1=O] |
| 5-1 | 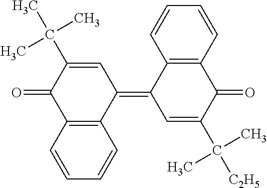 [SMILES: CCC(C)(C)C1=C/C(=C2/C=C(C(C)(C)C)C(=O)c3ccccc32)c2ccccc2C1=O] |
| 6-1 | 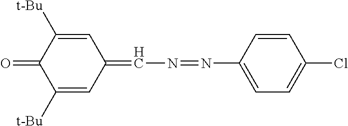 [SMILES: CC(C)(C)C1=CC(=CN=Nc2ccc(Cl)cc2)C=C(C(C)(C)C)C1=O] |
| 7-1 | 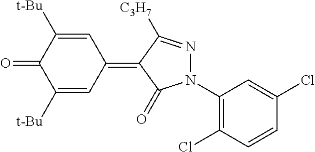 |
| 8-1 | 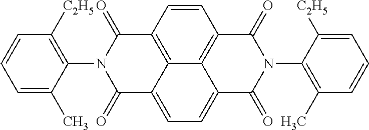 [SMILES: CCc1cccc(C)c1N1C(=O)c2ccc3c4c(ccc(c24)C1=O)C(=O)N(c1c(C)cccc1CC)C3=O] |
| 9-1 | 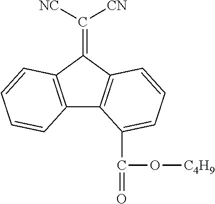 |
| 10-1 | 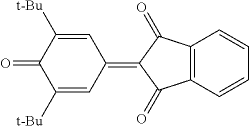 [SMILES: CC(C)(C)C1=CC(=C2C(=O)c3ccccc3C2=O)C=C(C(C)(C)C)C1=O] |
| 11-1 | 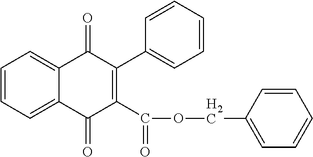 [SMILES: O=C(OCc1ccccc1)C1=C(c2ccccc2)C(=O)c2ccccc2C1=O] |
| 12-1 | 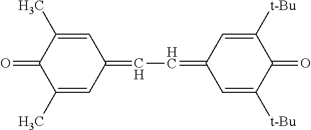 [SMILES: CC1=CC(=CC=C2C=C(C(C)(C)C)C(=O)C(C(C)(C)C)=C2)C=C(C)C1=O] |

A content ratio (mass ratio) between the charge-generating substance and the resin is preferably from 1:1,000 to 50:100, more preferably from 5:1,000 to 30:100.

A content ratio (mass ratio) between the hole-transporting substance and the resin is preferably from 1:10 to 20:10, more preferably from 1:10 to 10:10.

A content ratio (mass ratio) between the electron-transporting substance and the resin is preferably from 5:100 to 10:10, more preferably from 1:10 to 8:10.

In addition, the photosensitive layer may comprise an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The silica particles are preferably added for improving the durability of the photosensitive layer.

The silica particles are preferably subjected to surface treatment with a surface treatment agent. Examples of the surface treatment agent include hexamethyldisilazane, N-methyl-hexamethyldisilazane, hexamethyl-N-propyldisilazane, dimethyldichlorosilane, and polydimethylsiloxane. The surface treatment agent is particularly preferably hexamethyldisilazane.

The content of the silica particles is preferably 0.5 to 15 parts by mass with respect to 100 parts by mass of the binder resin (A). In addition, the content is more preferably 1 to 10 parts by mass.

The particle diameter (number-average primary particle diameter) of the silica particles is preferably 7 to 1,000 nm, more preferably 10 to 300 nm.

The photosensitive layer has an average thickness of preferably 5 to 100 μm, more preferably 10 to 50 μm.

The photosensitive layer may be formed by preparing and applying a coating liquid for a photosensitive layer comprising the above-mentioned materials and a solvent, forming a coat thereof, and drying the coat. Examples of the solvent to be used for the coating liquid for a photosensitive layer include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

(2) Laminated Photosensitive Layer

The laminated photosensitive layer comprises the charge-generating layer and the charge-transporting layer.

The charge-generating layer comprises the charge-generating substance and a resin, and the charge-transporting layer comprises the hole-transporting substance and a resin.

Examples of the charge-generating substance, the hole-transporting substance, and the resin are the same as those of the materials in the section “(1) Single-layer Photosensitive Layer.”

The content of the charge-generating substance in the charge-generating layer is preferably 40 to 85 mass %, more preferably 60 to 80 mass % with respect to the total mass of the charge-generating layer.

The charge-generating layer has an average thickness of preferably 0.1 to 1 μm, more preferably 0.15 to 0.4 μm.

The content of the hole-transporting substance in the charge-transporting layer is preferably 25 to 70 mass %, more preferably 30 to 55 mass % with respect to the total mass of the charge-transporting layer.

A content ratio (mass ratio) between the hole-transporting substance and the resin is preferably from 4:10 to 20:10, more preferably from 5:10 to 12:10.

In addition, the charge-generating layer and the charge-transporting layer may each comprise any one of the additives listed in the section “(1) Single-layer Photosensitive Layer.”

The charge-transporting layer has an average thickness of 5 to 50 μm, more preferably 8 to 40 μm, particularly preferably 10 to 30 μm.

[Image Forming Apparatus and Image Forming Method Comprising Using the Apparatus]

In addition, the image forming apparatus of the present disclosure is characterized by comprising: the electrophotographic photosensitive member that has heretofore been described; a charging unit and an exposing unit serving as an image forming unit configured to form an electrostatic image on the electrophotographic photosensitive member; a developing unit comprising a toner configured to supply the toner to the electrostatic image for forming a toner image; and a transferring unit configured to transfer the toner image from the electrophotographic photosensitive member onto a transfer target member, such as paper.

An example of the schematic construction of an image forming apparatus comprising a process cartridge comprising an electrophotographic photosensitive member is illustrated in FIGURE.

A cylindrical electrophotographic photosensitive member 1 is rotationally driven about a shaft 2 in an arrow direction at a predetermined peripheral speed. The surface of the electrophotographic photosensitive member 1 is charged to a predetermined positive or negative potential by a charging unit 3. Although a roller charging system based on a roller type charging member is illustrated in the FIGURE, a charging system, such as a corona charging system, a proximity charging system, or an injection charging system, may be adopted. The charged surface of the electrophotographic photosensitive member 1 is irradiated with exposure light 4 from an exposing unit (not shown), and hence an electrostatic latent image corresponding to target image information is formed thereon. The electrostatic latent image formed on the surface of the electrophotographic photosensitive member 1 is developed with a toner stored in a developing unit 5, and a toner image is formed on the surface of the electrophotographic photosensitive member 1. The toner image formed on the surface of the electrophotographic photosensitive member 1 is transferred onto a transfer material 7 by a transferring unit 6. The transfer material 7 onto which the toner image has been transferred is conveyed to a fixing unit 8, is subjected to treatment for fixing the toner image to form an image on the transfer material 7, and is printed out to the outside of the image forming apparatus. The image forming apparatus may comprise a cleaning unit 9 for removing a deposit, such as the toner remaining on the surface of the electrophotographic photosensitive member 1 after the transfer. In addition, a so-called cleaner-less system configured to remove the deposit with the developing unit or the like without separate arrangement of the cleaning unit may be used. The image forming apparatus may comprise an electricity-removing mechanism configured to subject the surface of the electrophotographic photosensitive member 1 to electricity-removing treatment with pre-exposure light 10 from a pre-exposing unit (not shown). In addition, a guiding unit 12, such as a rail, may be arranged for removably mounting a process cartridge 11 of the present disclosure onto the main body of an image forming apparatus.

The electrophotographic photosensitive member of the present disclosure may be used in, for example, a laser beam printer, an LED printer, a copying machine, a facsimile, and a multifunctional peripheral thereof.

According to the present disclosure, there can be provided the image forming apparatus and the image forming method in each of which no image smearing occurs even under high-temperature and high-humidity conditions while the durability of the electrophotographic photosensitive member and the low-temperature fixability of the toner are maintained.

### EXAMPLES

The present disclosure is described in more detail below by way of Examples and Comparative Examples. The present disclosure is by no means limited to the following Examples, and various modifications may be made without departing from the gist of the present disclosure. In the description in the following Examples, “part(s)” is by mass unless otherwise specified.

### Production Example of Resin 1

The following materials were prepared.
Diol represented by the following formula (13): 13.3 g

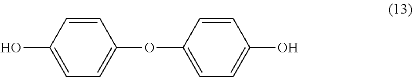 [SMILES: Oc1ccc(Oc2ccc(O)cc2)cc1]

Diol represented by the following formula (14): 36.7 g

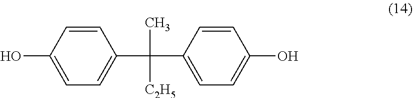 [SMILES: CCC(C)(c1ccc(O)cc1)c1ccc(O)cc1]

Hydrosulfite: 0.1 g

Those materials were dissolved in 1,100 ml of a 5 mass % aqueous solution of sodium hydroxide. 500 ml of methylene chloride was added to the solution, and the temperature of the mixture was maintained at 15° C. while the mixture was stirred. Next, 60.0 g of phosgene was blown into the mixture over 60 minutes.

After the completion of the blowing of phosgene, 1.0 g of p-t-butylphenol was added as a molecular weight modifier to the reaction liquid, and the reaction liquid was stirred to be emulsified. After the emulsification, 0.3 ml of triethylamine was added to the emulsified product, and the mixture was stirred at 23° C. for 1 hour to be polymerized.

After the completion of the polymerization, the reaction liquid was separated into an aqueous phase and an organic phase. The organic phase was neutralized with phosphoric acid, and the neutralized product was repeatedly washed with water until the conductivity of a washed liquid (aqueous phase) became 10 μS/cm or less. The resultant polymer solution was dropped in warm water kept at 45° C., and the solvent was removed by evaporation. Thus, a white powdery precipitate was obtained. The resultant precipitate was filtered out, and was dried at 110° C. for 24 hours to provide a resin 1.

It was recognized by ¹H-NMR that the resultant resin 1 was a resin having 30 mol % of a structure derived from the compound represented by the formula (13) and 70 mol % of a structure derived from the compound represented by the formula (14).

### Production Examples of Resins 2 to 13

Resins were each produced in the same manner as in the resin 1 except that in the production of the resin 1, the diols to be used were changed, and the amounts of the diols were adjusted so that the resin to be obtained had a molar ratio shown in Table 1.

### Production Example of Electrophotographic Photosensitive Member D-1

3.0 Parts of a metal-free phthalocyanine pigment serving as a charge-generating substance, 60.0 parts of a compound represented by the following general formula (15), which served as a hole-transporting substance, 12.0 parts of the compound represented by the formula (4-1) in Table 2 and 28.0 parts of the compound represented by the formula (5-1) in Table 2, which served as electron-transporting substances, 1.0 part of silica particles (AEROSIL RX200) subjected to surface treatment with hexamethyldisilazane, 100 parts of the resin 1 having a weight-average molecular weight (Mw) of 30,000, which served as a binder resin, and 800 parts of tetrahydrofuran serving as a solvent were loaded into a vessel.

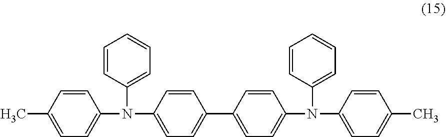

The materials and the solvent in the vessel were mixed with a rod-shaped ultrasonic disperser for 2 minutes so that the materials were dispersed in the solvent. Further, the materials and the solvent were mixed with a ball mill for 50 hours so that the materials were dispersed in the solvent. Thus, a coating liquid for a single-layer photosensitive layer was prepared.

The coating liquid for a single-layer photosensitive layer was applied onto an aluminum tube serving as a conductive substrate by dip coating, and the applied liquid was dried at 100° C. for 40 minutes. Thus, an electrophotographic photosensitive member D-1 whose photosensitive layer had a thickness of 25 μm was produced.

### Production Examples of Electrophotographic Photosensitive Members D-2 to D-29

Electrophotographic photosensitive members D-2 to D-29 were each produced in the same manner as in the production example of the electrophotographic photosensitive member D-1 except that the binder resin (A), the addition amount of the silica particles, and the electron-transporting substances were changed as shown in Table 3 below. The terms “4-1”, “4-2”, “5-1”, “6-1”, “7-1”, “8-1”, “9-1”, “10-1”, “11-1”, and “12-1” shown as electron-transporting substances refer to the compounds represented by the formulae (4-1), (4-2), (5-1), (6-1), (7-1), (8-1), (9-1), (10-1), (11-1), and (12-1) in Table 2, respectively.

TABLE 3

| | | | | Electron- |
|---|---|---|---|---|
| | | Silica | | transporting |
| | | particle | | substance |
| | | content | | content |
| | | (with respect | | (with respect |
| Photo- | Binder | to 100 parts | Electron- | to 100 parts |
| sensitive | resin | of binder | transporting | of binder |
| member | (A) | resin (A)) | substance | resin (A)) |
| D-1 | Resin 1 | 1 | 4-1/5-1 | 12/28 |
| D-2 | Resin 2 | 1 | 4-1/5-1 | 12/28 |
| D-3 | Resin 3 | 1 | 4-1/5-1 | 12/28 |
| D-4 | Resin 4 | 1 | 4-1/5-1 | 12/28 |
| D-5 | Resin 5 | 1 | 4-1/5-1 | 12/28 |
| D-6 | Resin 6 | 1 | 4-1/5-1 | 12/28 |
| D-7 | Resin 7 | 1 | 4-1/5-1 | 12/28 |
| D-8 | Resin 8 | 1 | 4-1/5-1 | 12/28 |
| D-9 | Resin 9 | 1 | 4-1/5-1 | 12/28 |
| D-10 | Resin 10 | 1 | 4-1/5-1 | 12/28 |
| D-11 | Resin 11 | 1 | 4-1/5-1 | 12/28 |
| D-12 | Resin 12 | 1 | 4-1/5-1 | 12/28 |
| D-13 | Resin 13 | 1 | 4-1/5-1 | 12/28 |
| D-14 | Resin 1 | 0.5 | 4-1/5-1 | 12/28 |
| D-15 | Resin 1 | 5 | 4-1/5-1 | 12/28 |
| D-16 | Resin 1 | 10 | 4-1/5-1 | 12/28 |
| D-17 | Resin 1 | 15 | 4-1/5-1 | 12/28 |
| D-18 | Resin 1 | 20 | 4-1/5-1 | 12/28 |
| D-19 | Resin 1 | 0.1 | 4-1/5-1 | 12/28 |
| D-20 | Resin 1 | 0.1 | 4-2 | 40 |
| D-21 | Resin 1 | 0.1 | 5-1 | 40 |
| D-22 | Resin 1 | 0.1 | 6-1 | 30 |
| D-23 | Resin 1 | 0.1 | 7-1 | 30 |
| D-24 | Resin 1 | 0.1 | 8-1 | 30 |
| D-25 | Resin 1 | 0.1 | 9-1 | 30 |
| D-26 | Resin 1 | 0.1 | 10-1 | 30 |
| D-27 | Resin 1 | 0.1 | 11-1 | 30 |
| D-28 | Resin 1 | 0.1 | 12-1 | 30 |
| D-29 | Resin 1 | None | 4-1/5-1 | 12/28 |
| D-30 | Resin 14 | None | 4-1/5-1 | 12/28 |
| D-31 | Resin 15 | 1 | 4-1/5-1 | 12/28 |
| D-32 | Resin 16 | None | 4-1/5-1 | 12/28 |

### Production Example of Electrophotographic Photosensitive Member D-30

An electrophotographic photosensitive member D-30 was produced in the same manner as in the production example of the electrophotographic photosensitive member D-29 except that the resin 1 serving as a binder resin was changed to a resin 14, which comprised a repeating unit represented by the following general formula (16) and had a weight-average molecular weight (Mw) of 30,000.

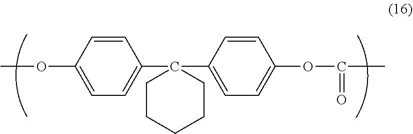

### Production Example of Electrophotographic Photosensitive Member 31

An electrophotographic photosensitive member D-31 was produced in the same manner as in the production example of the electrophotographic photosensitive member D-1 except that the resin 1 serving as a binder resin was changed to a resin 15, which comprised a repeating unit represented by the following general formula (17) and had a weight-average molecular weight (Mw) of 30,000.

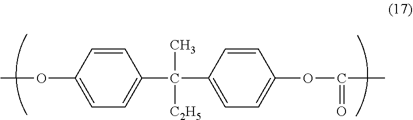

### Production Example of Electrophotographic Photosensitive Member 32

An electrophotographic photosensitive member D-32 was produced in the same manner as in the production example of the electrophotographic photosensitive member D-1 except that the resin 1 serving as a binder resin was changed to a resin 16 formed of a structure represented by the following general formula (18) and a structure represented by the following general formula (19).

A molar ratio between the structure represented by the general formula (18) and the structure represented by the general formula (19) in the resin 16 is 30:70, and the weight-average molecular weight (Mw) of the resin 16 is 30,000.

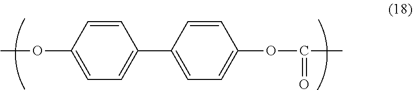

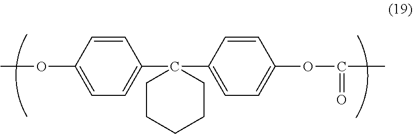

<Production of Wax A-1>

100 Parts of behenyl alcohol serving as an alcohol and 80 parts of stearic acid serving as a carboxylic acid were loaded into a reaction vessel comprising a temperature gauge, a nitrogen-introducing tube, a stirring machine, a Dean-Stark trap, and a Dimroth condenser, and an esterification reaction therebetween was performed at 200° C. for 15 hours. 20 Parts of toluene and 25 parts of isopropanol were added to the resultant ester compound, and 190 parts of a 10% aqueous solution of potassium hydroxide, the amount corresponding to an amount 1.5 times as large as the acid value of the ester compound, was added to the mixture, followed by stirring at 70° C. for 4 hours. After that, the aqueous phase portion was removed.

Further, 20 parts of ion-exchanged water was loaded into the vessel, and the mixture was stirred at 70° C. for 1 hour. After that, the aqueous phase portion was removed and washed. The washing step was repeated until the pH of the removed aqueous phase became neutral. After that, the solvent was removed under reduced pressure under the conditions of 200° C. and 1 kPa. Thus, behenyl stearate (wax A-1), which was an ester compound of behenyl alcohol and stearic acid serving as the final target product, was obtained. The physical properties of the resultant wax A-1 are shown in Table 4.

<Production of Wax A-2>

In the production example of the wax A-1, eicosyl alcohol serving as an alcohol and eicosanoic acid serving as a carboxylic acid, whose molar amount was 1.05 times as large as that of eicosyl alcohol, were loaded into the vessel, and a reaction therebetween was performed in a stream of nitrogen at 220° C. and normal pressure for 15 hours while water produced by the reaction was evaporated. Thus, an esterified crude product was obtained.

Eicosyl eicosanoate (wax A-2) was obtained in the same manner as in the production example of the wax A-1 except the foregoing. The physical properties of the resultant wax A-2 are shown in Table 4.

<Production of Wax A-3>

In the production example of the wax A-1, stearyl alcohol serving as an alcohol and behenic acid serving as a carboxylic acid, whose molar amount was 1.05 times as large as that of stearyl alcohol, were loaded into the vessel, and a reaction therebetween was performed in a stream of nitrogen at 220° C. and normal pressure for 15 hours while water produced by the reaction was evaporated. Thus, an esterified crude product was obtained.

Stearyl behenate (wax A-3) was obtained in the same manner as in the production example of the wax A-1 except the foregoing. The physical properties of the resultant wax A-3 are shown in Table 4.

<Production of Wax A-4>

In the production example of the wax A-1, eicosanoic acid serving as a carboxylic acid, whose molar amount was 1.05 times as large as that of behenyl alcohol, was loaded into the vessel, and a reaction therebetween was performed in a stream of nitrogen at 220° C. and normal pressure for 15 hours while water produced by the reaction was evaporated. Thus, an esterified crude product was obtained.

Behenyl eicosanoate (wax A-4) was obtained in the same manner as in the production example of the wax A-1 except the foregoing. The physical properties of the resultant wax A-4 are shown in Table 4.

<Production of Wax A-5>

In the production example of the wax A-1, tetracosyl alcohol serving as an alcohol and palmitic acid serving as a carboxylic acid, whose molar amount was 1.05 times as large as that of tetracosyl alcohol, were loaded into the vessel, and a reaction therebetween was performed in a stream of nitrogen at 220° C. and normal pressure for 15 hours while water produced by the reaction was evaporated. Thus, an esterified crude product was obtained.

Tetracosyl palmitate (wax A-5) was obtained in the same manner as in the production example of the wax A-1 except the foregoing. The physical properties of the resultant wax A-5 are shown in Table 4.

<Production of Wax A-6>

In the production example of the wax A-1, behenic acid serving as a carboxylic acid, whose molar amount was 1.08 times as large as that of behenyl alcohol, was loaded into the vessel, and a reaction therebetween was performed in a stream of nitrogen at 220° C. and normal pressure for 15 hours while water produced by the reaction was evaporated. Thus, an esterified crude product was obtained.

Behenyl behenate (wax A-6) was obtained in the same manner as in the production example of the wax A-1 except the foregoing. The physical properties of the resultant wax A-6 are shown in Table 4.

TABLE 4

| Wax | A-1 | A-2 | A-3 | A-4 | A-5 | A-6 |
|---|---|---|---|---|---|---|
| Monoester | Behenyl | Eicosyl | Stearyl | Behenyl | Tetracosyl | Behenyl |
| compound | stearate | eicosanoate | behenate | eicosanoate | palmitate | behenate |
| represented by | | | | | | |
| general | | | | | | |
| formula (3) | | | | | | |
| Number of | 17 | 19 | 21 | 19 | 15 | 21 |
| carbon atoms | | | | | | |
| of group | | | | | | |
| represented by | | | | | | |
| R³¹ | | | | | | |
| Number of | 22 | 20 | 18 | 22 | 24 | 22 |
| carbon atoms | | | | | | |
| of group | | | | | | |
| represented by | | | | | | |
| R³² | | | | | | |
| Number of | 40 | 40 | 40 | 42 | 40 | 44 |
| carbon atoms | | | | | | |
| per one | | | | | | |
| molecule | | | | | | |
| Melting point | 67 | 65 | 70 | 74 | 72 | 75 |
| (° C.) | | | | | | |
| Acid value | 0.1 | 0.1 | 0.1 | 0.1 | 0.1 | 1.1 |

<Production of Toner T-1>
Polymerizable monomer: 74 parts of styrene and 26 parts of n-butyl acrylate
Colorant: 7 parts of carbon black (product name: #25B, manufactured by Mitsubishi Chemical Corporation)
Cross-linking agent: 0.74 part of divinylbenzene
Charge control agent: 0.37 part of a styrene/acrylic resin (product name: FCA-592P, manufactured by Fujikura Kasei Co., Ltd.)
Molecular weight modifier: 1 part of tetraethylthiuram disulfide
Macromonomer: 0.25 part of a polymethacrylic acid ester macromonomer (product name: AA6, manufactured by Toagosei Co., Ltd., glass transition temperature Tg=94° C.)

The above-mentioned materials were stirred and mixed with a typical stirring apparatus. After that, the materials were uniformly dispersed with a media type dispersing machine, and were warmed to 63° C.

20 Parts of the wax A-1 was added, mixed, and dissolved in the uniformly dispersed materials to provide a polymerizable monomer composition. Separately, in a stirring tank, under room temperature, an aqueous solution obtained by dissolving 4.1 parts of sodium hydroxide in 50 parts of ion-exchanged water was gradually added to an aqueous solution, which was obtained by dissolving 7.4 parts of magnesium chloride in 250 parts of ion-exchanged water, under stirring. Thus, a magnesium hydroxide colloidal dispersion (comprising 3.0 parts of magnesium hydroxide) was prepared.

The above-mentioned polymerizable monomer composition was loaded into the magnesium hydroxide colloidal dispersion obtained in the foregoing under room temperature. The temperature of the mixture was increased to 60° C., and the mixture was stirred until its liquid droplets were stabilized. 5 Parts of t-butylperoxy-2-ethylhexanoate (product name: PERBUTYL O, manufactured by NOF Corporation) was added as a polymerization initiator to the mixture. After that, the resultant mixture was subjected to high-shear stirring with an inline type emulsifying dispersing machine (product name: MILDER, manufactured by Pacific Machinery & Engineering Co., Ltd.) at a number of revolutions of 15,000 rpm. Thus, the liquid droplets of the polymerizable monomer composition were formed.

The magnesium hydroxide colloidal dispersion having dispersed therein the liquid droplets of the polymerizable monomer composition was loaded into a reactor mounted with a stirring blade. A temperature in the reaction system was increased to 89° C., and a polymerization reaction was performed while the temperature was controlled so as to be constant. Next, when the polymerization conversion ratio of the dispersion reached 98%, the temperature in the system was cooled to 75° C. 15 Minutes after the temperature had reached 75° C., 3 parts of methyl methacrylate serving as a polymerizable monomer for a shell and 0.36 part of 2,2′-azobis[2-methyl-N-(1,1-bis(hydroxymethyl)-2-hydroxyethyl)propionamide] tetrahydrate (product name: VA-086, manufactured by Wako Pure Chemical Industries, Ltd.) dissolved in 10 parts of ion-exchanged water were added to the resultant. Further, the polymerization was continued for 3 hours, and then the reaction was terminated. Thus, an aqueous dispersion of colored resin particles having a pH of 9.5 was obtained.

After that, the temperature of the aqueous dispersion of the colored resin particles was set to 80° C., and the dispersion was subjected to a stripping treatment at a nitrogen gas flow rate of 0.6 m³/(hr·kg) for 5 hours. After that, the aqueous dispersion was cooled to 25° C. Next, while the resultant aqueous dispersion was stirred at 25° C., the pH of the system was set to 6.5 or less with sulfuric acid, followed by acid washing. After water had been separated by filtration, 500 parts of ion-exchanged water was newly added to turn the residue into a slurry again, and the slurry was washed with water. After that, dehydration and water washing were repeatedly performed several times again, and the solid content was separated by filtration. After that, the solid content was loaded into a drying machine, and was dried at 40° C. for 12 hours to provide toner particles.

0.7 Part of hydrophobized silica fine particles having a number-average primary particle diameter of 7 nm and 1 part of hydrophobized silica fine particles having a number-average primary particle diameter of 50 nm were added to 100 parts of the toner particles obtained in the foregoing, and the materials were mixed with a high-speed stirring machine (product name: FM MIXER, manufactured by Nippon Coke & Engineering Co., Ltd.) to produce a toner T-1.

<Production of Toners T-2 to T-11>

Toners T-2 to T-11 were each produced in the same manner as in the method of producing the toner T-1 except that the kind or addition amount of the wax was changed as shown in Table 5. A paraffin wax (product name: HNP-51, manufactured by Nippon Seiro Co., Ltd., melting point: 78° C.) was used as a wax A-7. The characteristics of the resultant toners are shown in Table 5.

TABLE 5

| Toner | T-1 | T-2 | T-3 | T-4 | T-5 | T-6 | T-7 | T-8 | T-9 | T-10 | T-11 |
|---|---|---|---|---|---|---|---|---|---|---|---|
| Wax | A-1 | A-2 | A-3 | A-4 | A-5 | A-6 | A-1 | A-1 | A-1 | A-1 | A-7 |
| Wax addition | 20 | 20 | 20 | 20 | 20 | 20 | 10 | 30 | 5 | 35 | 20 |
| amount (part(s)) | | | | | | | | | | | |
| 1/2 Method | 125 | 124 | 125 | 125 | 124 | 125 | 124 | 124 | 125 | 125 | 125 |
| melting | | | | | | | | | | | |
| temperature Tm | | | | | | | | | | | |
| (° C.) | | | | | | | | | | | |
| Glass transition | 51 | 51 | 51 | 50 | 52 | 51 | 53 | 50 | 54 | 49 | 55 |
| temperature Tg | | | | | | | | | | | |
| (° C.) | | | | | | | | | | | |
| Number-average | 8,700 | 8,600 | 8,500 | 8,750 | 8,600 | 8,500 | 8,800 | 8,700 | 8,800 | 8,600 | 8,500 |
| molecular weight | | | | | | | | | | | |
| (Mn) | | | | | | | | | | | |
| Weight-average | 243,600 | 236,500 | 248,500 | 2,535,400 | 245,600 | 248,600 | 235,400 | 275,600 | 2,256,400 | 2,856,300 | 246,800 |
| molecular weight | | | | | | | | | | | |
| (Mw) | | | | | | | | | | | |
| Molecular weight | 28 | 28 | 29 | 290 | 29 | 29 | 27 | 32 | 256 | 332 | 29 |
| distribution | | | | | | | | | | | |
| (Mw/Mn) | | | | | | | | | | | |

### Example 1

A reconstructed machine of a monochrome laser printer HL-5200 manufactured by Brother Industries, Ltd. was used as an image forming apparatus. A high-voltage power supply control system (product name: Model 615-3, manufactured by TREK, Inc.) was used as a power supply for supplying power for a corona charger from the outside of the printer. Then, the quantity of a current flowing through the corona wire of the corona charger was adjusted to 500 μA.

A toner in a toner cartridge for the printer was removed, and the toner T-1 was loaded thereinto instead. In addition, the electrophotographic photosensitive member of a drum unit for the printer was removed, and the electrophotographic photosensitive member D-1 whose initial thickness had been measured for a durability evaluation was set therein instead.

The toner cartridge and the drum unit were mounted on the image forming apparatus, and the apparatus was left to stand under an environment having a temperature of 30° C. and a humidity of 80% RH for 24 hours or more, followed by the performance of the following evaluations. The results are shown in Table 6.

(Image Smearing Evaluation)

An image having an image print percentage of 3% was output on 30,000 sheets of A4 vertical size paper. After that, the supply of power to the evaluation apparatus was terminated, and the apparatus was halted for 3 days.

After the 3 days of halting, the supply of power to the evaluation apparatus was started again, and a lattice image and a letter image (E-letter image) in which an alphabetical letter E (font type: Times, font size: 6 points) was repeated were output on A4 vertical size paper. The resultant images were each visually evaluated for an image defect-suppressing effect in accordance with the following evaluation ranks. The effect becomes more satisfactory as the number of a rank increases. Ranks 5, 4, and 3 were judged as levels at which the image defect-suppressing effect of the present disclosure was obtained. Meanwhile, ranks 1 and 2 were judged as levels at which the image defect-suppressing effect of the present disclosure was not obtained.

Rank 5: No image defect is found in each of the lattice image and the E-letter image.
Rank 4: The lattice image partially blurs, but no image defect is found in the E-letter image.
Rank 3: The lattice image partially blurs, and the E-letter image partially pales.
Rank 2: The lattice image partially disappears, and the E-letter image entirely pales.
Rank 1: The lattice image entirely disappears, and the E-letter image entirely pales.

(Durability Evaluation)

The electrophotographic photosensitive member D-1 used in the image smearing evaluation was evaluated for the amount of a reduction in thickness of the photosensitive layer on the surface of its central portion from the initial value. At that time, the thickness was measured with a thickness-measuring machine FISCHER MMS EDDY CURRENT PROBE EAW3.3 manufactured by Fischer Instruments K.K. The amount of the reduction in thickness of the photosensitive layer was evaluated based on a value obtained by converting the amount of a reduction in thickness after image output on 30,000 sheets into an amount per 1,000 sheets.

(Low-Temperature Fixability Evaluation)

The fixing device of the above-mentioned image forming apparatus was reconstructed so that its fixation temperature could be arbitrarily set. A solid black image having a print percentage of 100% was output with the apparatus on FOX RIVER BOND PAPER (110 g/m²), which was rough paper, while the fixation temperature of the fixing device was controlled within the range of from 180° C. to 230° C. in increments of 5° C. At this time, whether or not a blank dot portion was present in the image of the solid image portion was visually evaluated, and the lowest temperature at which the blank dot portion occurred was adopted as the result of a low-temperature fixability evaluation.

Rank 5: The blank dot occurs at less than 190° C.
Rank 4: The blank dot occurs at 190° C. or more and less than 200° C.
Rank 3: The blank dot occurs at 200° C. or more and less than 210° C.
Rank 2: The blank dot occurs at 210° C. or more and less than 220° C.
Rank 1: The blank dot occurs at 220° C. or more.

### Examples 2 to 9

An image smearing evaluation, a durability evaluation, and a low-temperature fixability evaluation were performed in the same manner as in Example 1 except that the electrophotographic photosensitive member D-1 and the toner T-1 were changed as shown in Table 6. The results are shown in Table 6. In Table 6, the column “General formula (1)/binder resin (A)” shows the molar ratio I of the structure represented by the general formula (1) to the binder resin (A) of the surface layer, and the column “General formula (3)/binder resin (B)” shows the molar ratio II of the monoester compound represented by the general formula (3) to the binder resin (B) of the toner.

TABLE 6

| | | | I | II | | | Durability | |
|---|---|---|---|---|---|---|---|---|
| | Electro- | | General | General | | | evaluation | Low- |
| | photographic | | formula | formula (3)/ | | Image | Shaved | temperature |
| | photosensitive | | (1)/binder | binder resin | | smearing | amount | fixability |
| | member | Toner | resin (A) (%) | (B) (%) | I/II | evaluation | (μm) | evaluation |
| Example 1 | D-1 | T-1 | 30 | 20 | 1.5 | 5 | 1.1 | 5 |
| Example 2 | D-1 | T-7 | 30 | 10 | 3.0 | 5 | 1.2 | 5 |
| Example 3 | D-1 | T-8 | 30 | 30 | 1.0 | 5 | 1 | 5 |
| Example 4 | D-3 | T-8 | 35 | 30 | 1.2 | 5 | 1.1 | 5 |
| Example 5 | D-4 | T-1 | 40 | 20 | 2.0 | 5 | 1.1 | 5 |
| Example 6 | D-5 | T-7 | 50 | 10 | 5.0 | 4 | 1.2 | 4 |
| Example 7 | D-4 | T-9 | 40 | 5 | 8.0 | 4 | 1.2 | 4 |
| Example 8 | D-2 | T-8 | 25 | 30 | 0.8 | 3 | 1.5 | 5 |
| Example 9 | D-6 | T-10 | 20 | 35 | 0.6 | 3 | 1.6 | 4 |

### Examples 10 to 37 and Comparative Examples 1 to 3

An image smearing evaluation, a durability evaluation, and a low-temperature fixability evaluation were performed in the same manner as in Example 1 except that the electrophotographic photosensitive member D-1 and the toner T-1 were changed as shown in Table 7. The results are shown in Table 7.

TABLE 7

| | Electro- | | | | |
|---|---|---|---|---|---|
| | photo- | | | Durability | |
| | graphic | | | evaluation | Low- |
| | photo- | | Image | shaved | temperature |
| | sensitive | | smearing | amount | fixability |
| | member | Toner | evaluation | (μm) | evaluation |
| Example 10 | D-7 | T-1 | 5 | 1.3 | 5 |
| Example 11 | D-8 | T-1 | 5 | 1.5 | 5 |
| Example 12 | D-9 | T-1 | 5 | 1.6 | 5 |
| Example 13 | D-10 | T-1 | 5 | 1.6 | 5 |
| Example 14 | D-11 | T-1 | 5 | 1.2 | 5 |
| Example 15 | D-12 | T-1 | 5 | 1.5 | 5 |
| Example 16 | D-13 | T-1 | 5 | 1.2 | 5 |
| Example 17 | D-14 | T-1 | 5 | 1.4 | 5 |
| Example 18 | D-15 | T-1 | 5 | 1.0 | 5 |
| Example 19 | D-16 | T-1 | 5 | 0.9 | 5 |
| Example 20 | D-17 | T-1 | 5 | 0.9 | 5 |
| Example 21 | D-18 | T-1 | 4 | 0.9 | 5 |
| Example 22 | D-19 | T-1 | 5 | 1.7 | 5 |
| Example 23 | D-20 | T-1 | 5 | 1.1 | 5 |
| Example 24 | D-21 | T-1 | 5 | 1.2 | 5 |
| Example 25 | D-22 | T-1 | 5 | 1.1 | 5 |
| Example 26 | D-23 | T-1 | 5 | 1.3 | 5 |
| Example 27 | D-24 | T-1 | 5 | 1.2 | 5 |
| Example 28 | D-25 | T-1 | 5 | 1.1 | 5 |
| Example 29 | D-26 | T-1 | 5 | 1.0 | 5 |
| Example 30 | D-27 | T-1 | 5 | 1.3 | 5 |
| Example 31 | D-28 | T-1 | 5 | 1.3 | 5 |
| Example 32 | D-29 | T-1 | 5 | 1.8 | 5 |
| Example 33 | D-1 | T-2 | 4 | 1.1 | 5 |
| Example 34 | D-1 | T-3 | 5 | 1.1 | 5 |
| Example 35 | D-1 | T-4 | 5 | 1.1 | 4 |
| Example 36 | D-1 | T-5 | 5 | 1.1 | 5 |
| Example 37 | D-1 | T-6 | 5 | 1.1 | 4 |
| Comparative | D-31 | T-11 | 5 | 1.9 | 1 |
| Example 1 | | | | | |
| Comparative | D-32 | T-11 | 5 | 1.1 | 1 |
| Example 2 | | | | | |
| Comparative | D-32 | T-1 | 1 | 1.1 | 5 |
| Example 3 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-217513, filed Nov. 29, 2019, which is hereby incorporated by reference herein in its entirety.

What is claimed is:

1. An image forming apparatus comprising:
an electrophotographic photosensitive member comprising a support and a photosensitive layer formed on the support;
an image forming unit configured to form an electrostatic image on the electrophotographic photosensitive member;
a developing unit comprising a toner and configured to supply the toner to the electrostatic image formed on the electrophotographic photosensitive member for forming a toner image; and
a transferring unit configured to transfer the toner image from the electrophotographic photosensitive member,
wherein
a surface layer of the electrophotographic photosensitive member comprises a binder resin (A), and
the toner comprises toner particles each comprising a binder resin (B) and a wax, and
wherein the binder resin (A) has a structure I represented by the general formula (1) and a structure II represented by the general formula (2), and
wherein the wax comprises a monoester compound represented by the following general formula (3): 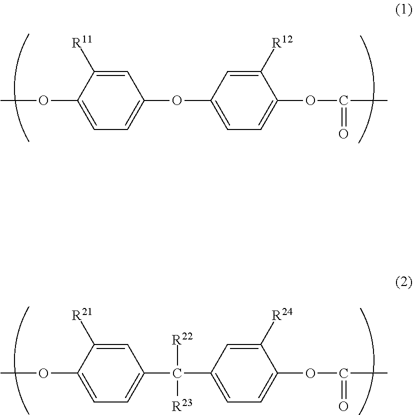
wherein, in the general formulae (1) and (2), R¹¹ and R¹², and R²¹ and R²⁴ each independently represent a hydrogen atom or a methyl group, and R²² and R²³ each independently represent a hydrogen atom, a methyl group, an ethyl group, or a phenyl group, or may form a cycloalkylidene group including a carbon atom to which R²² and R²³ are bonded;
R³¹—COO—R³² (3)
wherein, in the general formula (3), R³¹ and R³² each independently represent an alkyl group having 10 to 30 carbon atoms.

2. The image forming apparatus according to claim 1, wherein the binder resin (A) comprises the structure I represented by the general formula (1) and the structure II represented by the general formula (2) at a molar ratio (the structure I:the structure II) of from 25:75 to 70:30.

3. The image forming apparatus according to claim 1, wherein a ratio between a molar ratio I and a molar ratio II (the molar ratio I:the molar ratio II) is 3:1 to 1:1, wherein
the molar ratio I is a molar ratio of the structure I represented by the general formula (1) to the binder resin (A) comprised in the surface layer, and
the molar ratio II is a molar ratio of the monoester compound represented by the general formula (3) to the binder resin (B) comprised in the toner.

4. The image forming apparatus according to claim 1, wherein in the general formula (2), R²² represents a methyl group and R²³ represents an ethyl group.

5. The image forming apparatus according to claim 1, wherein the surface layer comprises silica particles.

6. The image forming apparatus according to claim 5, wherein a content of the silica particles is 0.5 to 15 parts by mass with respect to 100 parts by mass of the binder resin (A).

7. The image forming apparatus according to claim 1, wherein the surface layer comprises at least one electron-transporting substance selected from the group consisting of electron-transporting substances represented by the following general formulae (4) to (12): 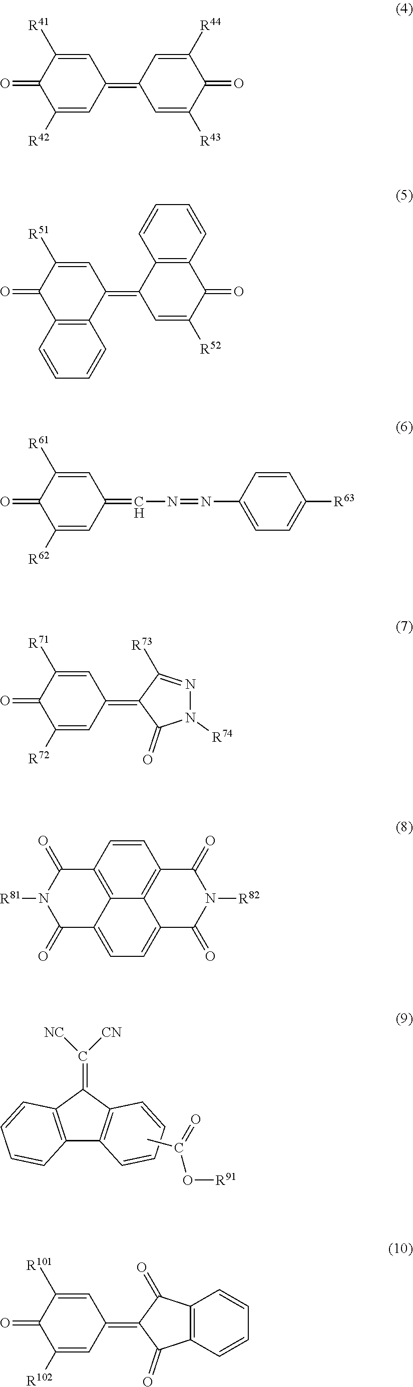 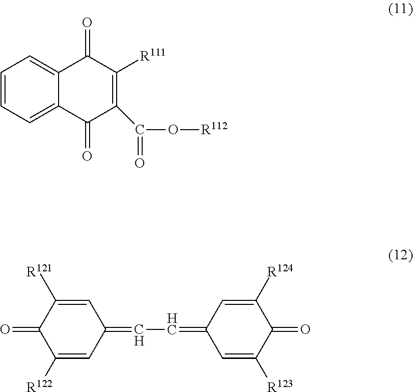
wherein, in the general formulae (4) to (12),
R⁴¹ to R⁴⁴, R⁵¹, R⁵², R⁶¹, R⁶², R⁷¹, to R⁷³, R¹⁰¹ and R¹⁰², and R¹²¹ to R¹²⁴ each independently represent a hydrogen atom or an alkyl group having 1 to 6 carbon atoms, and R⁶³ represents a hydrogen atom, a halogen atom, or an alkyl group having 1 to 6 carbon atoms,
R⁷⁴, R⁸¹, and R⁸² each independently represent an alkyl group having 1 to 6 carbon atoms, or a phenyl group that may have a halogen atom or an alkyl group having 1 to 6 carbon atoms,
R⁹¹ represents a hydrogen atom or an alkyl group having 1 to 6 carbon atoms that may have a halogen atom, and
R¹¹¹ and R¹¹² each independently represent an alkyl group having 1 to 6 carbon atoms that may have a halogen group, a phenyl group that may have a halogen group or an alkyl group having 1 to 6 carbon atoms, or a benzyl group that may have a halogen group or an alkyl group having 1 to 6 carbon atoms.

8. The image forming apparatus according to claim 1, wherein the photosensitive layer is a single-layer photosensitive layer comprising a charge-generating substance, a hole-transporting substance, an electron-transporting substance, and the binder resin (A).

9. The image forming apparatus according to claim 1, wherein the monoester compound represented by the general formula (3) comprised in the toner has 36 to 44 carbon atoms per one molecule thereof.

10. The image forming apparatus according to claim 1, wherein in the toner, the monoester compound represented by the general formula (3) has a melting point of 60 to 75° C.

11. The image forming apparatus according to claim 1, wherein the monoester compound represented by the general formula (3) comprised in the toner has an acid value of 1.0 mgKOH/g or less.

12. The image forming apparatus according to claim 1, wherein a content of the monoester compound represented by the general formula (3) comprised in the toner particles is 10 to 30 parts by mass with respect to 100 parts by mass of the binder resin (B).

13. An image forming method comprising using an image forming apparatus comprising:
an electrophotographic photosensitive member comprising a support and a photosensitive layer formed on the support;
an image forming unit configured to form an electrostatic image on the electrophotographic photosensitive member;
a developing unit comprising a toner and configured to supply the toner to the electrostatic image formed on the electrophotographic photosensitive member for forming a toner image; and
a transferring unit configured to transfer the toner image from the electrophotographic photosensitive member,
wherein a surface layer of the electrophotographic photosensitive member comprises a binder resin (A), and
the toner comprises toner particles each comprising a binder resin (B) and a wax, and
wherein the binder resin (A) has a structure represented by the general formula (1) and a structure represented by the general formula (2), and
wherein the wax comprises a monoester compound represented by the following general formula (3): 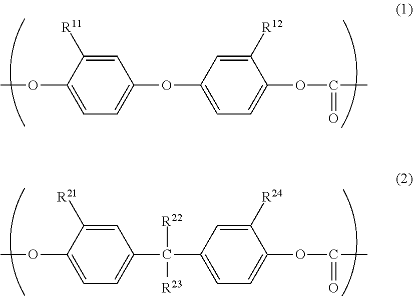
wherein, in the general formulae (1) and (2), R¹¹ and R¹², and R²¹ and R²⁴ each independently represent a hydrogen atom or a methyl group, and R²² and R²³ each independently represent a hydrogen atom, a methyl group, an ethyl group, or a phenyl group, or may form a cycloalkylidene group including a carbon atom to which R²² and R²³ are bonded;
R³¹—COO—R³² (3)
wherein, in the general formula (3), R³¹ and R³² each independently represent an alkyl group having 10 to 30 carbon atoms.
